(19) United States
(12) Patent Application Publication
(10) Pub. No.: US 2026/0244371 A1
(43) Pub. Date: Aug. 20, 2026

(54) STORAGE MEDIUM STORING APPLICATION PROGRAM THAT MAKES IT POSSIBLE TO PREVENT DUPLICATION OF USER INFORMATION ADDED TO JOB, CONTROL METHOD, AND INFORMATION PROCESSING APPARATUS

(71) Applicant: CANON KABUSHIKI KAISHA, Tokyo (JP)

(72) Inventor: HIDEKI SUGIYAMA, Kanagawa (JP)

(21) Appl. No.: 19/531,808

(22) Filed: Feb. 6, 2026

(30) Foreign Application Priority Data
Feb. 18, 2025 (JP) 2025-024271

(51) Int. Cl. G06F 3/12

(52) U.S. Cl. CPC G06F 3/121; G06F 3/1234; G06F 3/1239; G06F 3/1257; G06F 3/1273

(57) ABSTRACT

A non-transitory computer-readable storage medium storing an application program supporting a standard driver provided from a provider of an operating system. The application program causes a computer of an information processing apparatus to execute a control method of performing control to support the standard driver. Whether or not user information of an image forming apparatus has been added to a job to be executed by the image forming apparatus is determined. If it is determined that the user information has been added to the job, the job having the user information added thereto is transmitted to the image forming apparatus. If it is determined that the user information has not been added to the job, the user information is added to the job, and the job having the user information added thereto is transmitted to the image forming apparatus.

### BACKGROUND

### Field of the Technology

The present disclosure relates to a storage medium storing an application program that makes it possible to prevent duplication of user information added to a job, a control method, and an information processing apparatus.

### Description of the Related Art

As a general printing configuration, there is known a configuration that transmits print data to a printing apparatus by using a printer driver installed in an information processing apparatus. In the information processing apparatus, an operating system (OS) as basic software is installed. The printer driver is configured according to a print architecture specified by the OS and operates by being called by the OS. A vendor (maker) as a supplier that supplies a printing apparatus also supplies a printer driver conforming to the specifications of the OS. The OS and the printer driver realize a function of performing printing using the printing apparatus. The recent printer drivers place the importance on the security, but the extensibility of the printer driver itself tends to be lowered, compared with the conventional printer drivers. To compensate for the lowered extensibility, the vendor supplies a dedicated program for supporting the functions of the printer driver. The auxiliary program is sometimes referred to as the “hardware support application (HSA)” or the “print support application (PSA)”.

Further, a technique for controlling a printing apparatus according to a print program standardly incorporated in the OS (OS standard print program) has come into practical use. In this technique, the OS associates a printing apparatus with the OS standard print program. Then, in a case where a print instruction to the printing apparatus is received, printing based on the OS standard print program is enabled. As another technique related to printing, there is known, for example, a technique for managing availability/unavailability of the print function for each user. Further, as a technique related to printing, there is known a technique for adding user information to a print job generated by the OS standard print program using an auxiliary program and transmitting the print job, to which this user information has been added, to a printing apparatus (see Japanese Laid-Open Patent Publication (Kokai) No. 2022-109422). In the technique described in Japanese Laid-Open Patent Publication (Kokai) No. 2022-109422, based on the user information, the availability/unavailability of the print function of the printing apparatus is managed, i.e., whether printing can be or cannot be performed is determined.

However, in the technique described in Japanese Laid-Open Patent Publication (Kokai) No. 2022-109422, in a case where the OS standard print program or the printer driver adds the user information to a print job, this user information and the user information added by the auxiliary program are sometimes duplicated (discrepancy is caused). Then, in this case, there is a possibility that an erroneous operation occurs in the printing apparatus. For example, there is a possibility that the printing apparatus is stopped by determining that the erroneous operation is caused by a format error of the print job.

### SUMMARY

The present disclosure is directed to providing a mechanism that makes it possible to prevent duplication of user information added to a job.

In a first aspect of the present disclosure, there is provided a non-transitory computer-readable storage medium storing an application program supporting a standard driver provided from a provider of an operating system, the application program causing a computer of an information processing apparatus to execute a control method of performing control to support the standard driver, wherein the control method includes determining whether or not user information of an image forming apparatus has been added to a job to be executed by the image forming apparatus, and transmitting, in a case where it is determined that the user information has been added to the job, the job having the user information added thereto to the image forming apparatus, and adding, in a case where it is determined that the user information has not been added to the job, the user information to the job and transmitting the job having the user information added thereto to the image forming apparatus.

In a second aspect of the present disclosure, there is provided a control method of performing control to support a standard driver provided from a provider of an operating system, including determining whether or not user information of an image forming apparatus has been added to a job to be executed by the image forming apparatus, and transmitting, in a case where it is determined that the user information has been added to the job, the job having the user information added thereto to the image forming apparatus, and adding, in a case where it is determined that the user information has not been added to the job, the user information to the job and transmitting the job having the user information added thereto to the image forming apparatus.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram showing the entire configuration of a printing system according to a first embodiment.

FIG. 2 is a block diagram showing an example of a hardware configuration of the printing system.

FIG. 3A is a block diagram showing an example of a software configuration of the printing system.

FIG. 3B is a diagram useful in explaining restriction on use on a user-by-user basis, information of which is stored in a function DB of a management server.

FIG. 4 is a sequence diagram showing a process executed between a print application, a general-purpose print program, an auxiliary program, an image forming apparatus, and the management server.

FIGS. 5A and 5B are diagrams each showing an example of data of a print job.

FIG. 6 is a flowchart of a process including job information addition determination processing executed in a step of the sequence diagram shown in FIG. 4.

FIG. 7A is a flowchart of a process including job information addition determination processing according to a second embodiment.

FIG. 7B is a diagram showing an example of data of a print job.

FIG. 8A is a diagram useful in explaining restriction on use on a user-by-user basis, information of which is stored in the function DB of the management server according to a third embodiment.

FIG. 8B is a diagram showing an example of group information stored in the function DB of the management server.

FIG. 8C is a flowchart of a process including job information addition determination processing.

FIG. 8D is a diagram showing an example of data of a print job.

FIG. 9A is a diagram useful in explaining job history stored in the function DB of the management server according to a fourth embodiment.

FIG. 9B is a flowchart of a process including job information addition determination processing.

FIG. 9C is a diagram showing an example of data of a print job.

### DESCRIPTION OF THE EMBODIMENTS

The present disclosure will now be described in detail below with reference to the accompanying drawings showing embodiments thereof. Configurations described in the following embodiments are given only by way of example, and are by no means intended to limit the scope of the present disclosure. For example, components of the configuration of the present disclosure can be replaced with desired components which can exhibit the same functions. Further, desired components can be added. Further, two or more desired components (features) of the embodiments can be combined.

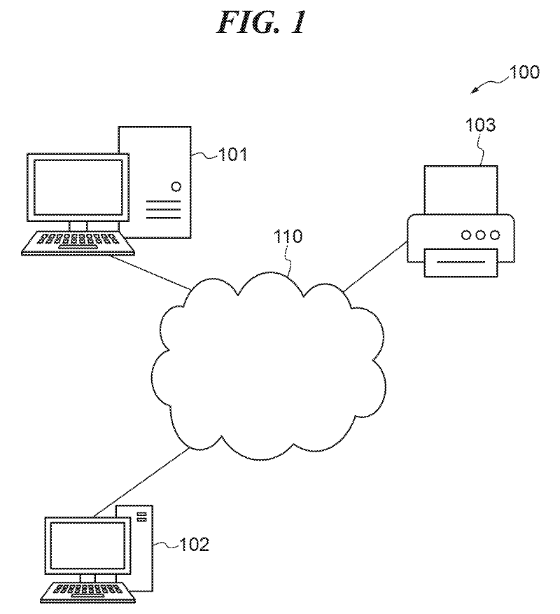

A first embodiment will be described below with reference to FIGS. 1 to 6. FIG. 1 is a schematic diagram showing the entire configuration of a printing system according to the first embodiment. As shown in FIG. 1, the printing system, denoted by reference numeral 100, has a management server 101, a client PC 102, and an image forming apparatus 103, and these are communicably connected to each other via a network 110. Note that although one client PC 102 is arranged in the configuration shown in FIG. 1, this is not limitative, but the client PC 102 can be provided in plurality. The management server 101 is formed by an information processing apparatus, such as a desktop-type personal computer. Note that the management server 101 can be formed by one information processing apparatus or by a plurality of information processing apparatuses. Further, the management server 101 can be a server system or can be virtually formed within one information processing apparatus. The management server 101 monitors states of, for example, the client PC 102 and the image forming apparatus 103 or performs management of a variety of settings, use conditions, described hereinafter, and job history. The client PC 102 is formed by an information processing apparatus, such as a desktop-type or laptop-type personal computer, a tablet terminal, or a smartphone. The client PC 102 is capable of executing a variety of programs, such as application programs. Further, in the client PC 102, a printer driver having a function of converting print data to a printer language supported by the image forming apparatus 103 is installed. The image forming apparatus 103 is formed by an apparatus capable of performing printing, such as a multi-function peripheral (MFP) or a single function printer (SFP). The image forming apparatus 103 receives a print job including print data, which is transmitted from the client PC 102, and performs printing. This printing method is not particularly limited, but for example, the electrophotographic method, the inkjet method, the thermal transfer method, or the like can be used.

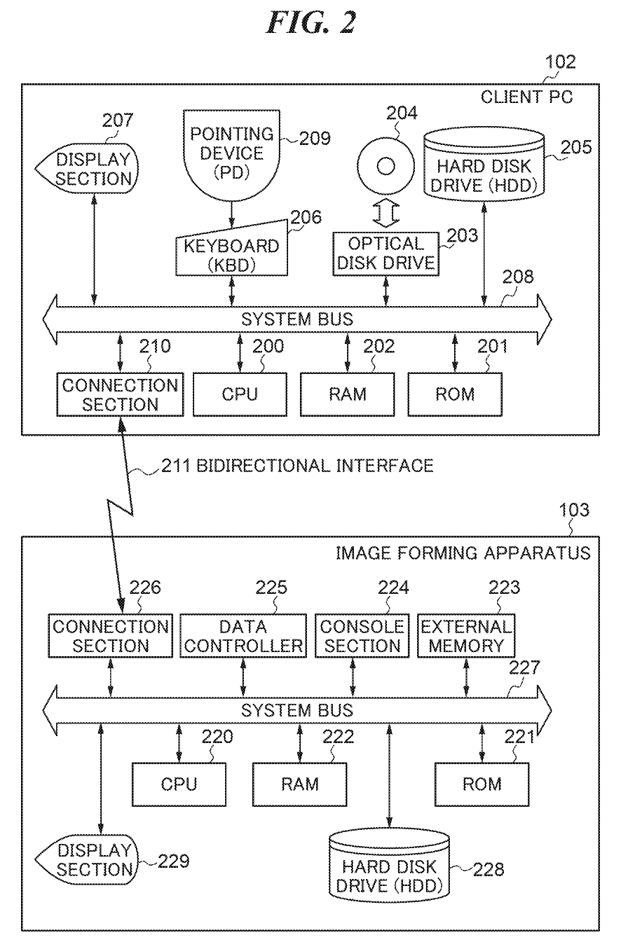

FIG. 2 is a block diagram showing an example of a hardware configuration of the printing system. As shown in FIG. 2, the client PC 102 includes a central processing unit (CPU) 200, a read only memory (ROM) 201, a random access memory (RAM) 202, an optical disk drive 203, such as a CD drive, a hard disk drive (HDD) 205, a keyboard (KBD) 206, a display section 207, and a connection section 210. These hardware items included in the client PC 102 are communicably connected to each other via a system bus 208. Further, a pointing device (PD) 209 is communicably connected to the keyboard 206. An optical disk 204, such as a CD, is inserted into the optical disk drive 203.

The CPU 200 functions as control means for controlling the overall operation of the client PC 102. The CPU 200 can operate a variety of programs, such as an application program and a printer driver, which are stored in a hard disk in the hard disk drive 205. The ROM 201 stores programs, such as an I/O program, and a variety of data items, such as font data used when a document is processed and data for templates. The RAM 202 functions as a main memory for the CPU 200, and further e.g. as a work area. Further, the RAM 202 temporarily stores information, a file, and the like, which are necessary for execution of a program. The optical disk drive 203 can read data from the optical disk 204. The optical disk in the hard disk drive 204 stores e.g. a program which can be executed by the CPU 200. The hard disk in the hard disk drive 205 stores, for example, the application program, the printer driver, the OS, and so forth. The keyboard 206 is used for an operation of inputting an instruction, such as a control command. The pointing device 209 functions as receiving means for receiving an instruction from a user. On the display section 207, a control command input from the keyboard 206, a state of the image forming apparatus 103, and so forth are displayed. The connection section 210 performs communication, i.e., transmits and receives data between the same and the image forming apparatus 103 via a bidirectional interface 211.

As shown in FIG. 2, the image forming apparatus 103 includes a CPU 220, a ROM 221, a RAM 222, an external memory 223, a console section 224, a data controller 225, a connection section 226, and a display section 229, and a hard disk drive (HDD) 228 incorporating a hard disk, and these are communicably connected to each other via a system bus 227. Note that the management server 101 also has the same hardware configuration as the image forming apparatus 103. The CPU 220 functions as control means for controlling the overall operation of the image forming apparatus 103. The CPU 220 transmits image signals to the data controller 225 based on a control program stored e.g. in the ROM 221 or the external memory 223. The ROM 221 stores a variety of data items, a control program for controlling the image forming apparatus 103, and so forth. The RAM 222 functions as a main memory for the CPU 200, and further e.g. as a work area. The external memory 223 is connected also as an option, and stores, for example, font data, an emulation program, form data, and so forth. The data controller 225 is a printer engine which is controlled by the CPU 220 and performs print processing corresponding to the image signals by the control program stored in the ROM 221 or the external memory 223. The console section 224 is comprised of an input section, such as an operation panel and operation switches, and a display section, such as a light emitting diode (LED) or a liquid crystal panel. The console section 224 can receive an operation from a user and display a result of the operation. With this, the user can confirm e.g. a state of settings of the image forming apparatus 103. The connection section 226 performs communication between the same and the client PC 102 via the bidirectional interface 211.

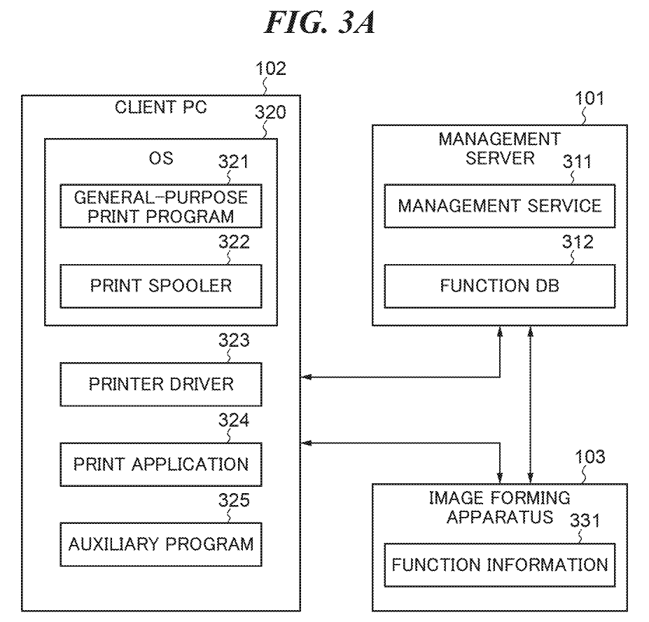

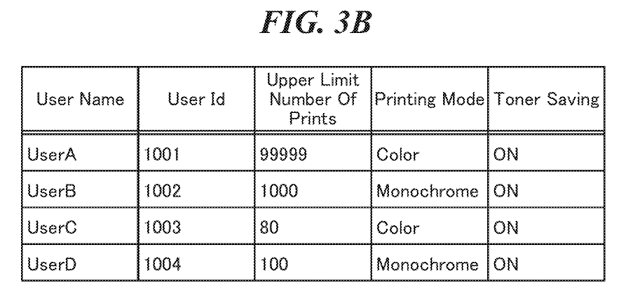

FIG. 3A is a block diagram showing an example of a software configuration of the printing system. As shown in FIG. 3A, the client PC 102 includes an OS 320, a printer driver 323, a print application 324, and an auxiliary program 325. These software items are in a state stored in a storage medium, such as the ROM 201. The OS 320 includes a general-purpose print program 321 and a print spooler 322. The general-purpose print program 321 is a standard driver provided from the provider of the OS 320. The general-purpose print program 321 can generate a print job for causing the image forming apparatus 103 to execute printing based on a user’s instruction. The print job is generated in an intermediate data form. The intermediate data form is not particularly limited, but, for example, a data form can be used which makes it possible to reflect a print instruction on a print original edited by the print application 324 and generate drawing data which can be printed by the image forming apparatus 103. Note that the intermediate data can be generated in a form which can be directly printed by the image forming apparatus 103. The print spooler 322 is software for queuing a print job to be transmitted and sequentially transmitting the print job to the image forming apparatus 103.

The printer driver 323 is software for generating a print job which can be printed by the image forming apparatus 103. The printer driver 323 is designed by the provider of the printer driver 323, and includes one conforming to a plurality of types of image forming apparatuses and one conforming to one type of image forming apparatus. The print application 324 is software for editing e.g. image data and document data. In a case where a print instruction using the print application 324 is provided, print data is generated by using the general-purpose print program 321 or the printer driver 323. This print data is passed to the print spooler 322. The print spooler 322 queues the print data as a print job and transmits the print job to the image forming apparatus 103.

The auxiliary program 325 is an application program supporting the general-purpose print program 321. This auxiliary program 325 is provided e.g. by a printer maker and added to the client PC 102 by installation. Similar to the printer driver 323, the auxiliary program 325 includes, for example, one conforming to a plurality of types of image forming apparatuses and one conforming to one type of image forming apparatus. This auxiliary program 325 can receive a plurality of types of commands from the print spooler 322 and execute a variety of processing operations based on these commands. The auxiliary program 325 can cause the CPU 200 to execute steps (control method), described hereinafter. Note that the auxiliary program 325 can be formed by a program combining a plurality of programs or by one program.

As shown in FIG. 3A, the image forming apparatus 103 includes function information 331. The function information 331 is in a state stored in a storage medium, such as the ROM 221. The function information 331 is, for example, setting information specific to the image forming apparatus 103, the number of printed sheets of each user, the job history, and operation information. The image forming apparatus 103 can notify part or all of the function information 331 in response to a request from the management server 101 or from the client PC 102.

As shown in FIG. 3A, the management server 101 includes a management service 311 and a function DB 312. The management service 311 manages e.g. restriction on use on a user-by-user basis, a setting of the job history, and the operation status. The “restriction on use on a user-by-user basis” refers to an execution range of a print job, which can be executed for each user. In the function DB 312, the restriction on use on a user-by-user basis, the setting of the job history, and the operation status are stored. In response to a request from the client PC 102 or from the image forming apparatus 103, the management service 311 can notify the restriction on use on a user-by-user basis, the setting of the job history, the operation information, and changes of settings, stored in the function DB 312, to the client PC 102 or from the image forming apparatus 103.

FIG. 3B is a diagram useful in explaining the restriction on use on a user-by-user basis, which is stored in the function DB of the management server. As shown in FIG. 3B, the restriction on use on a user-by-user basis includes, for example, the following three conditions: The first condition is an upper limit number of sheets which can be printed by the image forming apparatus 103. The second condition is a printing mode for setting whether to perform color printing or monochrome printing by the image forming apparatus 103. The third condition is a setting of whether to enable or disable toner saving for suppressing toner consumption. For example, for a user name “User A” having a user ID of “1001”, the upper limit number of sheets, the printing mode, and the toner saving are limited to “99999”, “color printing mode”, and “ON (enabled)”, respectively. In this case, if the accumulated number of printed sheets for the User A exceeds 99999, printing of sheets exceeding the 99999 sheets is inhibited. Note that the restriction on use on a user-by-user basis is only required to include at least one of these conditions. Further, the restriction on use on a user-by-user basis can include, for example, a setting of single-sided printing or double-sided printing, a setting of the number of pages which can be aggregated on one side of a sheet (aggregation printing), a sheet type setting, and a sheet size setting.

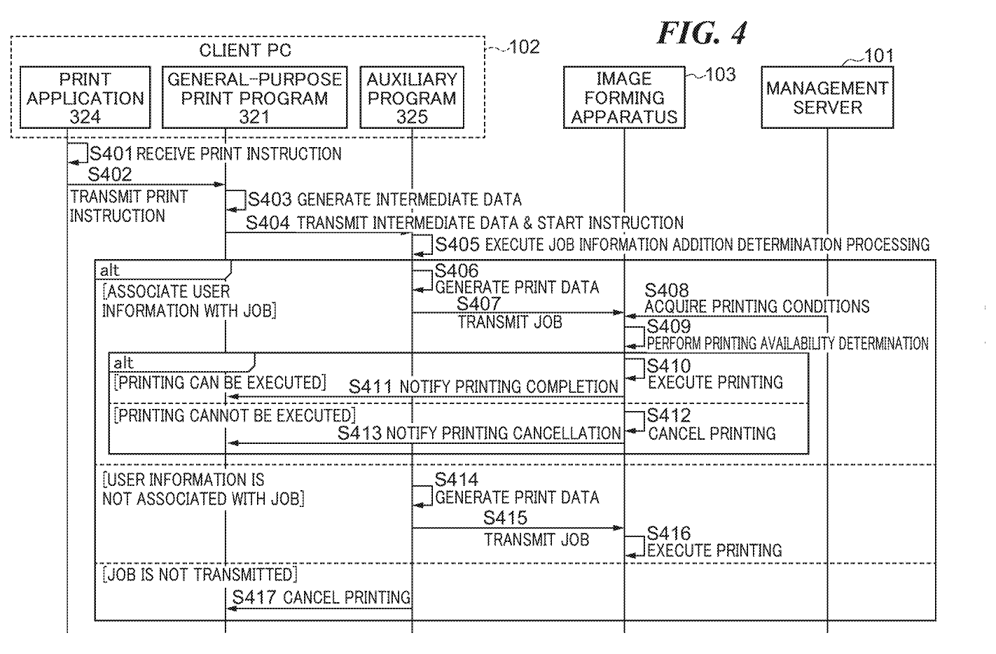

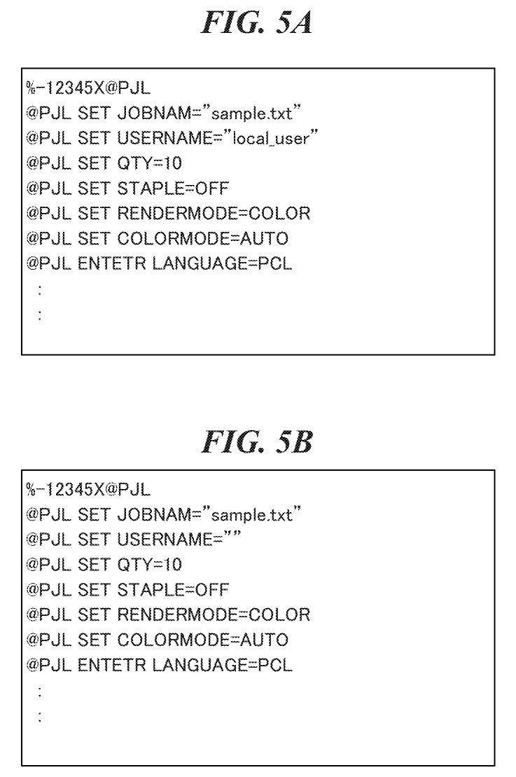

FIG. 4 is a sequence diagram showing a process executed between the print application 324, the general-purpose print program 321, the auxiliary program 325, the image forming apparatus 103, and the management server 101. Note that the auxiliary program 325 receives intermediate data of a print job from the general-purpose print program 321 and converts the received intermediate data to print data which can be printed by the image forming apparatus 103. Further, the intermediate data generated by the general-purpose print program 321 is print data of a format which can be interpreted by the image forming apparatus 103. The auxiliary program 325 appropriately sets job data in a form which can be interpreted by the image forming apparatus 103. FIGS. 5A and 5B are diagrams each showing an example of data of a print job. Referring to FIG. 4, in a step S401, the print application 324 receives a print instruction provided by a user’s operation on the client PC 102. The print instruction is provided on a print setting screen displayed on the display section 207 of the client PC 102. The print setting screen includes print setting items, such as a sheet size and the number of copies.

In a step S402, the print application 324 transmits the print instruction received in the step S401 to the general-purpose print program 321. This print instruction includes information related to the print setting items set on the print setting screen, and so forth.

In a step S403, the general-purpose print program 321 receives the print instruction transmitted in the step S402 and generates intermediate data based on this print instruction. As the image data included in the print instruction, there are a various types of image data. The general-purpose print program 321 converts this image data to data suitable for generation of print data and generates the intermediate data. Note that in a case where the image data included in the print instruction is data suitable for generation of print data, generation of the intermediate data can be omitted.

In a step S404, the general-purpose print program 321 instructs the auxiliary program 325 compatible with the image forming apparatus 103 to start the auxiliary program 325. Further, in the step S404, the general-purpose print program 321 transmits the print instruction received in the step S403 and the intermediate data generated in the step S403 to the auxiliary program 325.

In a step S405, the auxiliary program 325 receives the print instruction and the intermediate data, which are transmitted in the step S404, and executes job information addition determination processing, described hereinafter. In the job information addition determination processing, whether or not the user information of the image forming apparatus 103 has been added to a print job to be executed by the image forming apparatus 103 is determined. Note that the user information includes identification information for identifying a user who performs printing using the image forming apparatus 103 or a group to which this user belongs, and so forth. Then, the restriction on use on a user-by-user basis is specified based on this identification information. If it is determined in the job information addition determination processing that the user information has not been added to the print job, i.e., it is necessary to associate the user information with the print job, the process proceeds to a step S406. On the other hand, if it is determined that the user information has been added to the print job, i.e., the user information has already been associated with the print job, or the user information is not to be added to the print job, the process proceeds to a step S414.

In the step S406 after execution of the step S405, the auxiliary program 325 generates print data by converting the intermediate data received in the step S405 to data which can be printed by the image forming apparatus 103 and adds job information to the generated print data. The data of the print job, shown in FIG. 5A, shows an example of a state in which the user information has been added, i.e. associated. In this data, [@PJL SET USERNAME = ”local_user”] is described, and hence it is understood that the user name is set to “local_user”.

In a step S407, the auxiliary program 325 transmits the print data generated in the step S406, to which the job information has been added, to the image forming apparatus 103 as the print job.

In a step S408, the image forming apparatus 103 acquires the printing conditions (restriction on use on a user-by-user basis) from the management server 101. As the printing conditions, for example, in a case of the user name “User A” having the user ID “1001” appearing in FIG. 3B, the printing conditions that limit the upper limit number of sheets, the printing mode, and the toner saving to “99999”, “the color printing mode”, and “ON (enabled)”, respectively, are acquired.

In a step S409, the image forming apparatus 103 performs printing availability determination based on the printing conditions acquired in the step S407. For example, in a case of the user name “User A” having the user ID “1001” appearing in FIG. 3B, if the number of printed sheets is “90” at present, the printing mode is set to “the color printing mode”, and the toner saving is set to “ON”, it is determined that printing is available. In the case of this determination result, the process proceeds to a step S410. Further, in a case of a user name “User C” having a user ID “1003” appearing in FIG. 3B, if the number of printed sheets is “80” at present, the printing mode is set to “the color printing mode”, and the toner saving is set to “ON”, it is determined that printing is not available. In the case of this determination result, the process proceeds to a step S412.

In the step S410 after execution of the step S409, the image forming apparatus 103 executes the print job based on the print data transmitted in the step S407, i.e., executes printing.

In a step S411, in a case where execution of printing in the step S410 is completed, the image forming apparatus 103 notifies the general-purpose print program 321 of this fact.

In the step S412 after execution of the step S409, the image forming apparatus 103 cancels execution of the print job based on the print data transmitted in the step S407, i.e., does not execute printing.

In a step S413, the image forming apparatus 103 notifies the general-purpose print program 321 of cancellation of execution of the print job in the step S412.

In the step S414 after execution of the step S405, the auxiliary program 325 generates print data by converting the intermediate data received in the step S405 to data which can be printed by the image forming apparatus 103. The data of the print job shown in FIG. 5B shows an example of a state in which the user information has not been added to the print job. In this data, [@PJL SET USERNAME = ” ”] is described, and hence it is understood that the user name is not set.

In a step S415, the auxiliary program 325 transmits the print data generated in the step S414 to the image forming apparatus 103 as the print job.

In a step S416, the image forming apparatus 103 executes the print job based on the print data transmitted in the step S415, i.e., executes printing.

If it is determined in the step S405 that the print job is not to be transmitted, in a step S417, the auxiliary program 325 cancels execution of printing, i.e., does not transmit the data of the print job.

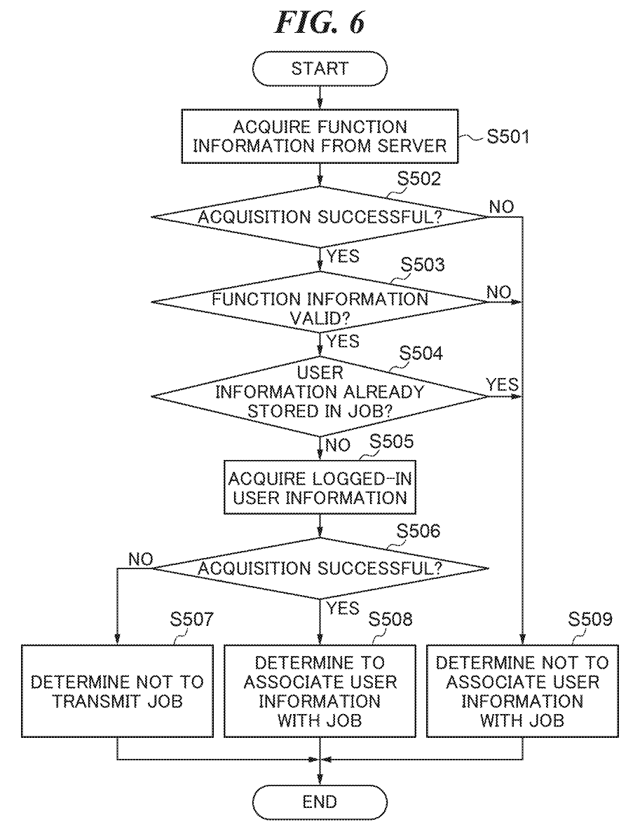

FIG. 6 is a flowchart of a process including the job information addition determination processing executed in the step S405 of the sequence diagram shown in FIG. 4. Referring to FIG. 6, in a step S501, the auxiliary program 325 acquires the function information, concerning the restriction on use on a user-by-user basis (printing conditions), of the image forming apparatus 103, which is stored in the function DB 312 of the management server 101, via the management service 311.

In a step S502, the auxiliary program 325 determines whether or not the function information has been successfully acquired in the step S501. This determination is performed e.g. based on whether or not the function information has been stored in the hard disk in the hard disk drive 205. In a case where the function information has been stored in the hard disk in the hard disk drive 205, it is determined that the function information has been successfully acquired, whereas in a case where the function information has not been stored in the hard disk in the hard disk drive 205, it is determined that the function information has not been successfully acquired, i.e. acquisition of the function information has failed. Then, if it is determined in the step S502 that the function information has been successfully acquired, the process proceeds to a step S503. On the other hand, if it is determined in the step S502 that acquisition of the function information has failed, the process proceeds to a step S509.

I n the step S503, the auxiliary program 325 determines whether or not the function information acquired in the step S501 is valid. This determination is performed, e.g. based on whether or not the function information can be applied to the normal operation in the image forming apparatus 103, i.e., whether or not the function information is set in the image forming apparatus 103 as valid information. In a case where it is determined that the function information can be applied to the image forming apparatus 103, it is determined that the function information is valid, whereas in a case where it is determined that the function information cannot be applied to the image forming apparatus 103, it is determined that the function information is not valid, i.e., invalid. Then, if it is determined in the step S503 that the function information is valid, the process proceeds to a step S504. On the other hand, if it is determined in the step S503 that the function information is invalid, the process proceeds to the step S509.

In the step S504, the auxiliary program 325 determines whether or not the user information of the image forming apparatus 103 has been added to the print job to be executed by the image forming apparatus 103, i.e., the user information has been stored. If it is determined in the step S504 that the user information has been stored, the process proceeds to the step S509. On the other hand, if it is determined in the step S504 that the user information has not been stored, the process proceeds to a step S505. For example, in the data of the print job shown in FIG. 5B, [@PJL SET USERNAME = ” ”] is described, and it is understood that the user name (user information) has not been stored. In this case, it is determined in the step S504 that the user information has not been stored.

In the step S505, the auxiliary program 325 acquires the user information of the user having logged in the client PC 102 e.g. from the hard disk in the hard disk drive 205.

In a step S506, the auxiliary program 325 determines whether or not the user information has been successfully acquired in the step S505. If it is determined in the step S506 that the user information has been successfully acquired, the process proceeds to a step S508. On the other hand, if it is determined in the step S506 that acquisition of the user information has failed, the process proceeds to a step S507.

In the step S507, the auxiliary program 325 determines not to transmit the print job to the image forming apparatus 103, followed by terminating the process.

In the step S508, the auxiliary program 325 determines that the user information acquired in the step S505 is to be added to the print job to thereby place the print job in an information added state, i.e., determines that the user information is to be associated with the print job, followed by terminating the process. For example, in a case where the data of the print job shown in FIG. 5B describes [@PJL SET USERNAME = ” ”], in which a user name is not described, it is determined in the step S504 that the user name has not been stored. In this case, in the step S508, the user name acquired in the step S505 is input between the double quotation marks of [@PJL SET USERNAME = ” ”]. With this, the print job is placed in the information added state. Then, the auxiliary program 325 transmits this print job in the information added state to the image forming apparatus 103.

In the step S509, the auxiliary program 325 determines that the user information is not to be associated with the print job, followed by terminating the process. For example, in a case where the data of the print job shown in FIG. 5A describes [@PJL SET USERNAME = ”local_user”], in which the user name is described as “local_user”, it is determined in the step S504 that the user name has been stored. In this case, in the step S509, the auxiliary program 325 transmits the print job in the information added state in which the user information (user name) has been added, to the image forming apparatus 103.

According to the above-described auxiliary program 325, in a case where the user information has already been added to the print job, the print job held in the information added state in which the user information has been added is transmitted to the image forming apparatus 103. On the other hand, in a case where the user information has not been added to the print job yet, the user information is added to the print job to place the print job in the information added state, and the print job in the information added state is transmitted to the image forming apparatus 103. Thus, it is possible to switch whether or not to add the user information according to whether or not the print job has already been in the information added state, and as a result, it is possible to prevent duplication of the user information added to the print job. With this, it is possible to prevent an erroneous operation of the image forming apparatus 103 due to duplication of the user information. Note that the print job and the user can be managed independently of each other. For example, the user information can be managed by the management server 101 in a state associated with the ID of the print job, and by inquiring of the management server 101 about the job ID when printing is performed by the image forming apparatus 103, the user information associated with this ID can be acquired.

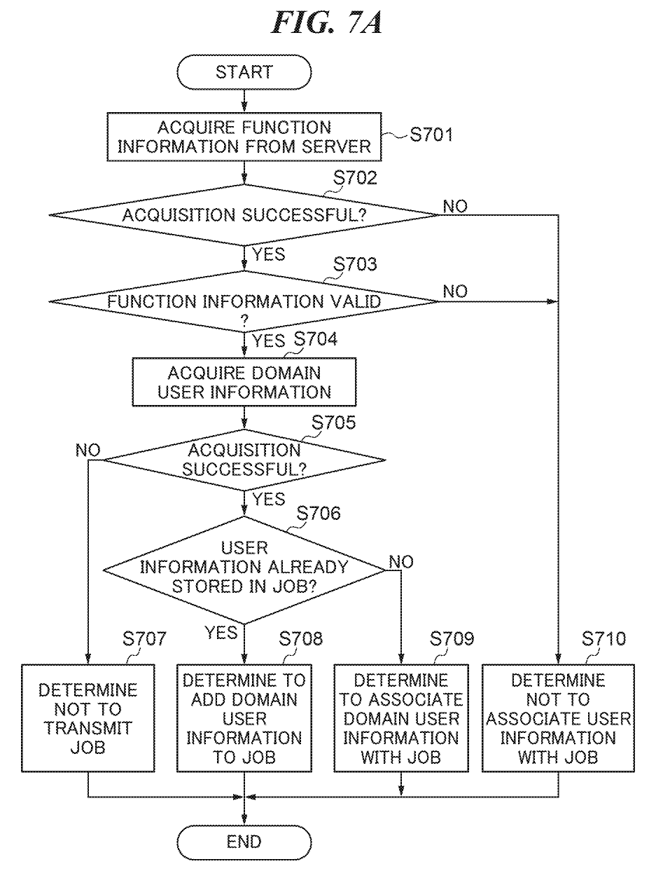

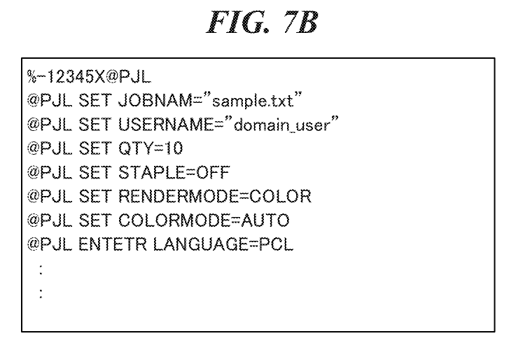

A second embodiment will be described below with reference to FIGS. 7A and 7B, but the description will be given mainly of different points from the above-described embodiment, and description of the same points is omitted. FIG. 7A is a flowchart of a process including the job information addition determination processing according to the second embodiment. FIG. 7B is a diagram showing an example of data of a print job. Referring to FIG. 7A, in a step S701, similar to the step S501, the auxiliary program 325 acquires the function information of the image forming apparatus 103.

In a step S702, similar to the step S502, the auxiliary program 325 determines whether or not the function information has been successfully acquired in the step S701. If it is determined in the step S702 that the function information has been successfully acquired, the process proceeds to a step S703. On the other hand, if it is determined in the step S702 that acquisition of the function information has failed, the process proceeds to a step S710.

In the step S703, the auxiliary program 325 determines whether or not the function information acquired in the step S701 is valid. If it is determined in the step S703 that the function information is valid, the process proceeds to a step S704. On the other hand, if it is determined in the step S703 that the function information is invalid, the process proceeds to the step S710.

In the step S704, the auxiliary program 325 acquires domain user information (domain information) as the user information e.g. from the hard disk in the hard disk drive 205. The “domain user information” refers to information related to the domain of the client PC 102, i.e., an apparatus incorporating the CPU 200 that executes the auxiliary program 325. Based on this domain information, the upper limit number of sheets, the printing mode, and the toner saving are specified as the restriction on use on a user-by-user basis, for the image forming apparatus 103.

In a step S705, the auxiliary program 325 determines whether or not the domain user information has been successfully acquired in the step S704. If it is determined in the step S705 that the domain user information has been successfully acquired, the process proceeds to a step S706. On the other hand, if it is determined in the step S705 that acquisition of the domain user information has failed, the process proceeds to a step S707. In the step S707, similar to the step S507, the auxiliary program 325 determines not to transmit the print job to the image forming apparatus 103, followed by terminating the process.

In the step S706, similar to the step S504, the auxiliary program 325 determines whether or not the user information has been stored in the print job. If it is determined in the step S706 that the user information has been stored, the process proceeds to a step S708. On the other hand, if it is determined in the step S706 that the user information has not been stored, the process proceeds to a step S709.

In the step S708, the auxiliary program 325 adds the domain user information acquired in the step S704 to the print job to set the print job in the information added state, i.e., determines to add the domain user information to the print job, followed by terminating the process. For example, in a case where the data of the print job shown in FIG. 7B describes [@PJL SET USERNAME = ”domain_User”], it is understood that the domain user information (domain user name) has been added.

In the step S709, the auxiliary program 325 determines to associate the domain user information (user information) acquired in the step S704 with the print job. Then, the auxiliary program 325 transmits this print job to the image forming apparatus 103, followed by terminating the process.

In the step S710, similar to the step S509, the auxiliary program 325 determines not to associate the user information with the print job and transmits this print job to the image forming apparatus 103, followed by terminating the process.

As described above, in the present embodiment, in a case where the user information has been stored in the print job, it is possible to further add the domain user information as other user information which is different from the user information. Then, it is possible to transmit the print job held in the state in which the domain user information has been added, to the image forming apparatus 103. With this, when the image forming apparatus 103 operates, in a case where the domain user information is required, this operation is normally performed.

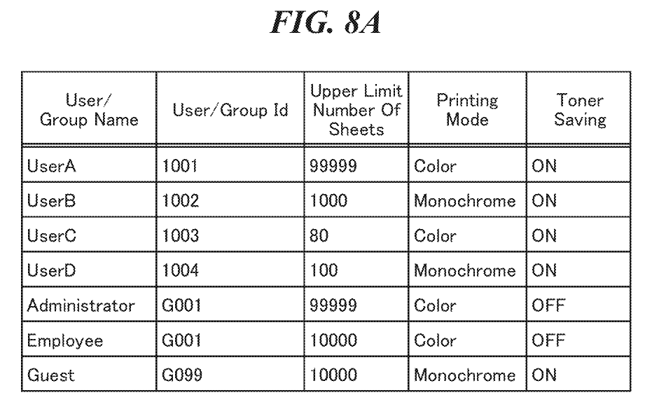

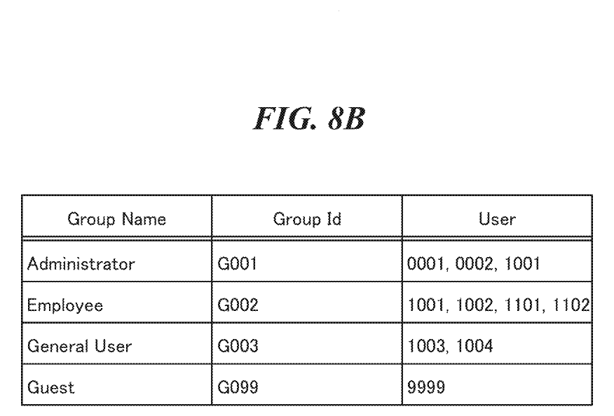

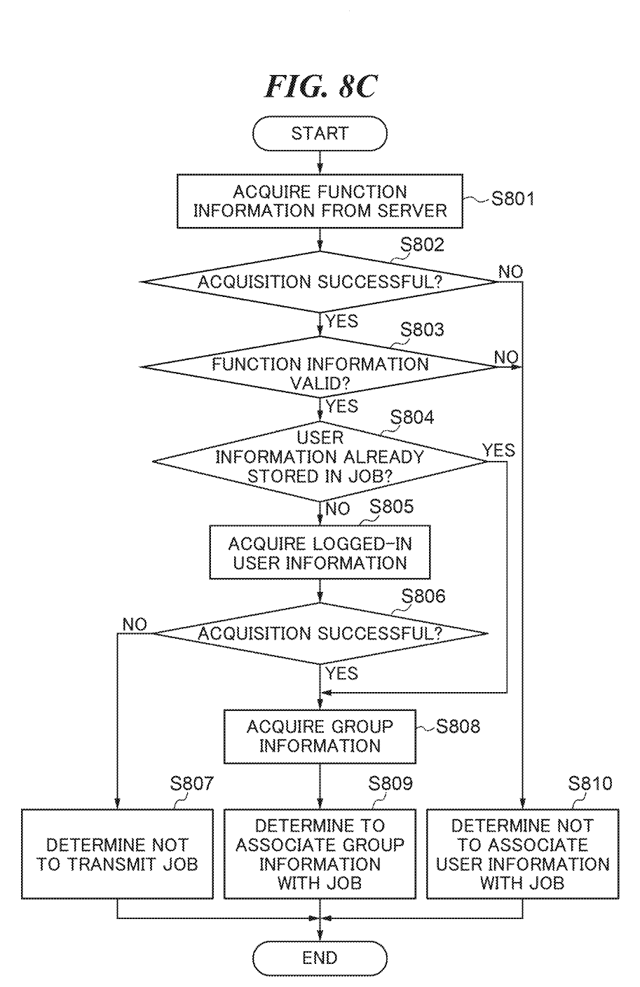

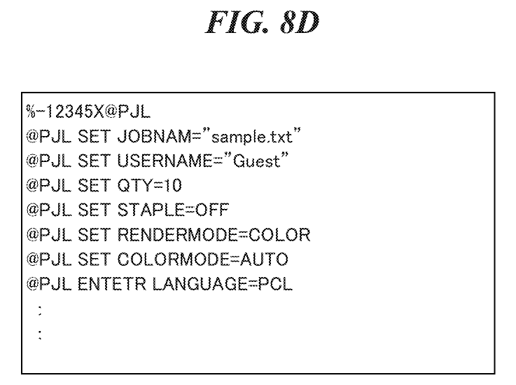

A third embodiment will be described below with reference to FIGS. 8A to 8D, but the description will be given mainly of different points from the above-described embodiments, and description of the same points is omitted. FIG. 8A is a diagram useful in explaining the restriction on use on a user-by-user basis, which is stored in the function DB of the management server according to the third embodiment. As shown in FIG. 8A, for example, for the user name “User A” belonging to a group having a group name “administrator” having a group ID “G001”, the upper limit number of sheets is set to “99999”.

FIG. 8B is a diagram showing an example of group information stored in the function DB of the management server. As shown in FIG. 8B, for example, a user having a user ID “1001” belongs to the group having the group name “administrator” having the group ID “G001”.

FIG. 8C is a flowchart of a process including the job information addition determination processing. FIG. 8D is a diagram showing an example of data of a print job. Referring to FIG. 8C, in a step S801, similar to the step S501, the auxiliary program 325 acquires the function information of the image forming apparatus 103.

In a step S802, similar to the step S502, the auxiliary program 325 determines whether or not the function information has been successfully acquired in the step S801. If it is determined in the step S802 that the function information has been successfully acquired, the process proceeds to a step S803. On the other hand, if it is determined in the step S802 that acquisition of the function information has failed, the process proceeds to a step S810.

In the step S803, the auxiliary program 325 determines whether or not the function information acquired in the step S801 is valid. If it is determined in the step S803 that the function information is valid, the process proceeds to a step S804. On the other hand, if it is determined in the step S803 that the function information is invalid, the process proceeds to the step S810.

In the step S804, similar to the step S504, the auxiliary program 325 determines whether or not the user information has been stored in the print job. If it is determined in the step S804 that the user information has been stored, the process proceeds to a step S808. On the other hand, if it is determined in the step S804 that the user information has not been stored, the process proceeds to a step S805.

In the step S805, similar to the step S505, the auxiliary program 325 acquires the user information of the user having logged in the client PC 102.

In a step S806, similar to the step S506, the auxiliary program 325 determines whether or not the user information has been successfully acquired in the step S805. If it is determined in the step S806 that the user information has been successfully acquired, the process proceeds to the step S808. On the other hand, if it is determined in the step S806 that acquisition of the user information has failed, the process proceeds to a step S807. In the step S807, similar to the step S507, the auxiliary program 325 determines not to transmit the print job to the image forming apparatus 103, followed by terminating the process.

In the step S808, the auxiliary program 325 acquires the group information e.g. from the hard disk in the hard disk drive 205, and then the process proceeds to a step S809.

In a step S809, the auxiliary program 325 determines to associate the group information acquired in the step S808 with the print job, followed by terminating the process. The job data shown in FIG. 8D describes [@PJL SET USERNAME = ”Guest”], and it is understood that the group name has been stored in place of the user name. Then, the auxiliary program 325 transmits this print job to the image forming apparatus 103. For example, in a case where the image forming apparatus 103 receives the job data shown in FIG. 8D, the group name “Guest” is transmitted to the management server 101 in the step S408 (see FIG. 4). The function information set with this group name “Guest” is used for printing. For example, in a case where the number of printed sheets for the group name “Guest” is 10000, this number of printed sheets is the upper limit number of sheets, and hence printing to be performed by the image forming apparatus 103 is canceled.

In the step S810, the auxiliary program 325 determines not to associate the user information with the print job, followed by terminating the process.

As described above, in the present embodiment, in a case where the user information has been stored in the print job, the user information can be changed to the group information as the user information. Then, the print job having the user information changed to the group information can be transmitted to the image forming apparatus 103. With this, when the image forming apparatus 103 operates, in a case where the group information is required, this operation is normally performed.

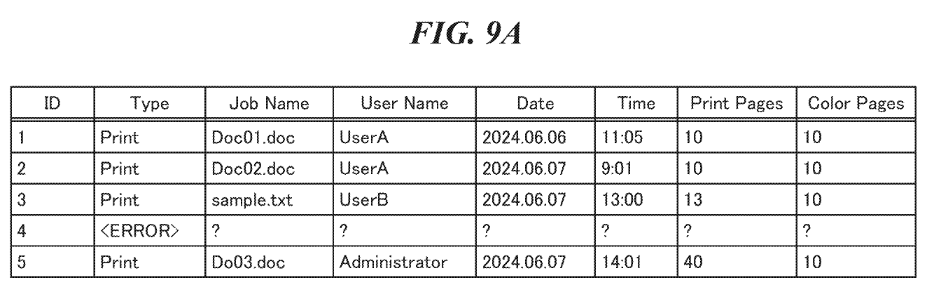

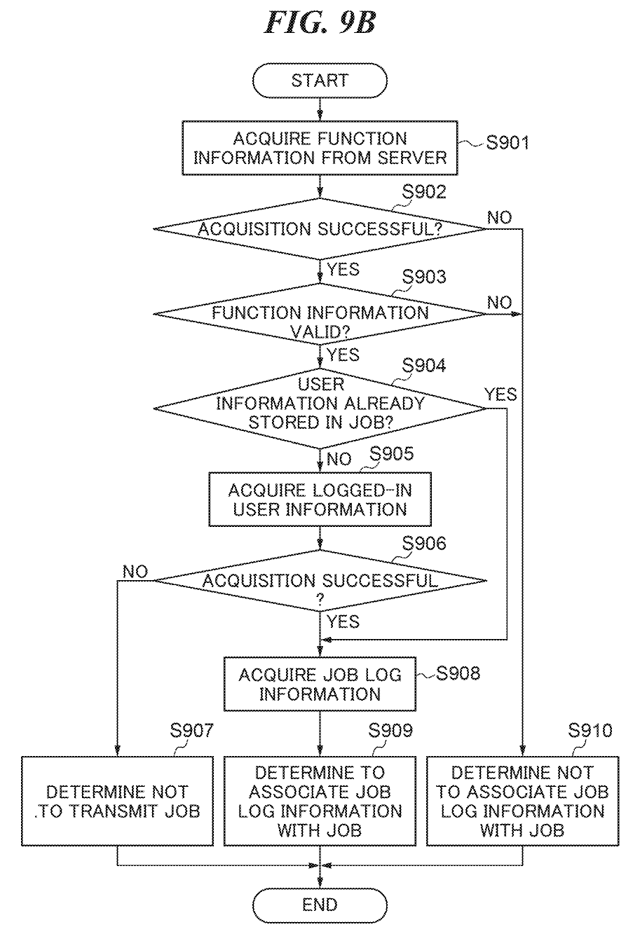

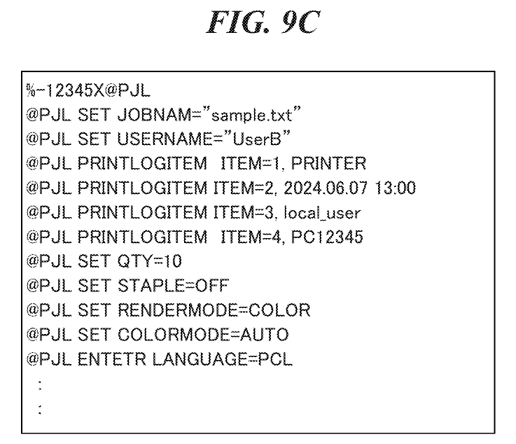

A fourth embodiment will be described below with reference to FIGS. 9A to 9C, but the description will be given mainly of different points from the above-described embodiments, and description of the same points is omitted. FIG. 9A is a diagram useful in explaining the job history stored in the function DB of the management server according to the fourth embodiment. The job history shown in FIG. 9A is related to execution history of print jobs executed in the image forming apparatus 103. This job history includes the following eight history items, for example: The first item is “ID” which is a number uniquely indicating a print job. The second item is “Type” indicating a print job type. The third item is “Job Neme” indicating a print job name. The fourth item is “User Name” indicating an executor of a print job. The fifth item is “Date” indicating an execution date of a print job. The sixth item is “Time” indicating an execution time of a print job. The seventh item is “Print Pages” indicating the number of printed sheets of a print job. The eighth item is “Color Pages” indicating the number of color printed sheets of a print job.

The management server 101 periodically collects the job history of the image forming apparatus 103. Therefore, the image forming apparatus 103 periodically transmits the job history to the management server 101. The management server 101 appropriately collects the job history and stores the job history in the function DB 312. The print spooler 322 holds the job information, such as the name of a document to be queued, a job execution time, a job size, sheet information, the number of sheets, and the number of copies. In the present embodiment, the print spooler 322 can send the job information in response to a request from the auxiliary program 325.

FIG. 9B is a flowchart of a process including the job information addition determination processing. FIG. 9C is a diagram showing an example of data of a print job. Referring to FIG. 9B, in a step S901, similar to the step S501, the auxiliary program 325 acquires the function information of the image forming apparatus 103. In the present embodiment, as the function information, information related to the function of collecting the job history is acquired.

In a step S902, similar to the step S502, the auxiliary program 325 determines whether or not the function information has been successfully acquired in the step S901. If it is determined in the step S902 that the function information has been successfully acquired, the process proceeds to a step S903. On the other hand, if it is determined in the step S902 that acquisition of the function information has failed, the process proceeds to a step S910.

In the step S903, the auxiliary program 325 determines whether or not the function information acquired in the step S901 is valid. If it is determined in the step S903 that the function information is valid, the process proceeds to a step S904. On the other hand, if it is determined in the step S903 that the function information is invalid, the process proceeds to the step S910.

In the step S904, similar to the step S504, the auxiliary program 325 determines whether or not the user information has been stored in the print job. If it is determined in the step S904 that the user information has been stored, the process proceeds to a step S908. On the other hand, if it is determined in the step S904 that the user information has not been stored, the process proceeds to a step S905.

In the step S905, similar to the step S505, the auxiliary program 325 acquires the user information of the user having logged in the client PC 102.

In a step S906, similar to the step S506, the auxiliary program 325 determines whether or not the user information has been successfully acquired in the step S905. If it is determined in the step S906 that the user information has been successfully acquired, the process proceeds to the step S908. On the other hand, if it is determined in the step S906 that acquisition of the user information has failed, the process proceeds to a step S907. In the step S907, similar to the step S507, the auxiliary program 325 determines not to transmit the print job to the image forming apparatus 103, followed by terminating the process.

In the step S908, the auxiliary program 325 acquires job log information e.g. from the hard disk in the hard disk drive 205, and the process proceeds to a step S909. The “job log information” refers to information, such as a print job type, a print job execution time, a print job executor, a print job input PC name, and a print document name.

In the step S909, the auxiliary program 325 determines to associate the job log information acquired in the step S908 with the print job, followed by terminating the process. The job data shown in FIG. 9C describes “@PJL PRINTLOGITEM ITEM”, and the print job type, the print job execution time, the print job executor, and the print job input PC name are set. In the image forming apparatus 103, the job data shown in FIG. 9C and the information generated by the image forming apparatus 103 are recorded e.g. in the hard disk in the hard disk drive 228 for each printing operation. These information items are notified in response to a request from the management server 101, or notified to the management server 101 for each printing operation as a printing result. With this, the job history can be accumulated.

In the step S910, the auxiliary program 325 determines not to associate the job log information with the print job, followed by terminating the process.

As described above, in the present embodiment, it is possible to add the job history as the other user information different from the user information. This makes it possible to execute the job history generation function of the image forming apparatus 103.

Although in the above-described embodiments, the job is assumed to be the print job, this is not limitative, but for example, the job can be e.g. a scan job depending on the function of the image forming apparatus 103. Further, although in the above-described embodiments, the application is distributed by a service having a software distribution function different from a management application, this is not limitative, but for example, the application can be distributed e.g. by the management application. Further, although in the above-described embodiments, in application distribution, when a distribution time comes, only application information which can be distributed is distributed in response to a request from the client PC 102, this is not limitative. For example, application distribution can be performed without setting the distribution time or can be forcibly performed even when a request form the client PC 102 is not received.

According to the present disclosure, it is possible to prevent duplication of the user information added to a job.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-024271, filed February 18, 2025, which is hereby incorporated by reference herein in its entirety.

What is claimed is:

1. A non-transitory computer-readable storage medium storing an application program supporting a standard driver provided from a provider of an operating system, the application program causing a computer of an information processing apparatus to execute a control method of performing control to support the standard driver,
wherein the control method comprises:
determining whether or not user information of an image forming apparatus has been added to a job to be executed by the image forming apparatus; and
transmitting, in a case where it is determined that the user information has been added to the job, the job having the user information added thereto to the image forming apparatus, and
adding, in a case where it is determined that the user information has not been added to the job, the user information to the job and transmitting the job having the user information added thereto to the image forming apparatus.

2. The non-transitory computer-readable storage medium according to claim 1, wherein the control method further comprises acquiring the user information in a case where it is determined that the user information has not been added to the job, and
wherein the transmitting includes adding the user information acquired by the acquiring to the job and transmitting the job having the user information added thereto to the image forming apparatus.

3. The non-transitory computer-readable storage medium according to claim 1, wherein the image forming apparatus is an apparatus that is capable of performing printing,
wherein the job is a print job,
wherein the user information includes identification information for identifying a user who performs printing using the image forming apparatus or a group to which the user belongs, and
wherein at least one of an upper limit number of sheets which can be printed by the image forming apparatus, and a printing mode for setting whether to perform color printing or monochrome printing by the image forming apparatus is specified as an execution range of the print job.

4. The non-transitory computer-readable storage medium according to claim 1, wherein in the transmitting, in a case where it is determined that the user information has been added to the job, it is possible to change the user information and transmit the job changed in the user information to the image forming apparatus.

5. The non-transitory computer-readable storage medium according to claim 1, wherein the transmitting includes further adding, in a case where it is determined that the user information has been added to the job, other user information different from the user information and transmitting the job having the other user information added thereto to the image forming apparatus.

6. The non-transitory computer-readable storage medium according to claim 5, wherein the other user information includes domain information related to the domain of an apparatus incorporating the computer, and at least one of an upper limit number of sheets which can be printed by the image forming apparatus, and a printing mode for setting whether to perform color printing or monochrome printing by the image forming apparatus is specified as an execution range of the job, based on the domain information.

7. The non-transitory computer-readable storage medium according to claim 5, wherein the other user information includes history information related to execution history of the job in the image forming apparatus.

8. The non-transitory computer-readable storage medium according to claim 1, wherein the application program is in a state stored in a storage medium.

9. A control method of performing control to support a standard driver provided from a provider of an operating system, comprising:
determining whether or not user information of an image forming apparatus has been added to a job to be executed by the image forming apparatus; and
transmitting, in a case where it is determined that the user information has been added to the job, the job having the user information added thereto to the image forming apparatus, and
adding, in a case where it is determined that the user information has not been added to the job, the user information to the job and transmitting the job having the user information added thereto to the image forming apparatus.

10. An information processing apparatus that includes a standard driver provided from a provider of an operating system and an application program supporting the standard driver, the application program causing a computer of the information processing apparatus to execute a control method of performing control to support the standard driver,
wherein the control method comprises:
determining whether or not user information of an image forming apparatus has been added to a job to be executed by the image forming apparatus; and
transmitting, in a case where it is determined that the user information has been added to the job, the job having the user information added thereto to the image forming apparatus, and
adding, in a case where it is determined that the user information has not been added to the job, the user information to the job and transmitting the job having the user information added thereto to the image forming apparatus.
